(19) United States
(12) Patent Application Publication
(10) Pub. No.: US 2017/0116868 A1
(43) Pub. Date: Apr. 27, 2017

(54) System and Method for Alerting to Collision Threats Between Recreational Objects and Locating Recreational Objects

(71) Applicant: Steven Paperno, Westlake Village, CA (US)

(72) Inventor: Steven Paperno, Westlake Village, CA (US)

(21) Appl. No.: 14/920,824

(22) Filed: Oct. 22, 2015

(51) Int. Cl. G08G 9/02; G08B 21/18

(52) U.S. Cl. CPC G08G 9/02; G08B 21/18

(57) ABSTRACT

A system and method for alerting to collision threats between recreational objects and locating recreational objects. The system helps a first and a second recreational object avoid collisions in recreational settings and also identifies the location of the first recreational object in emergency situations. The system utilizes wireless communication between the recreational objects to generate a collision alert that indicates a collision threat. A transponder, which integrates into the first recreational object, exchanges radio signals with a transmitter and a receiver integrated into the second recreational object. A processor interprets the strength and position of the communications to determine a potential collision threat. A controller generates a collision alert at the transponder when the collision threat is imminent. The transponder also emits an emergency signal from the first recreational object to a GPS enabled receiver or radio for indicating the location and emergency communications to the second recreational object.

### CROSS REFERENCE OF RELATED APPLICATIONS

This application refers to U.S. provisional application No. 62/060,471 filed Oct. 6, 2014 and entitled COLLISION AVOIDANCE SYSTEM AND METHOD FOR ALERTING TO COLLISION THREATS BETWEEN RECREATIONAL OBJECTS, which provisional application is incorporated by reference herein in its entirety.

### FIELD OF THE INVENTION

The present invention relates generally to a system and method for alerting to collision threats between moving objects, and locating recreational objects. More so, a system and method utilizes wireless communication between a first recreational object and a second recreational object moving towards each other in natural or semi-natural settings to alert against a collision threat, and also emits an emergency signal from any recreational object to indicate location and other emergency communications.

### BACKGROUND OF THE INVENTION

The invention teaches a system and method for alerting to collision threats between a first recreation object and a second recreational object moving towards each other. The system also identifies the location of any recreational object in emergency situations. The system and method utilizes a transponder, a transmitter, and a receiver, and a processor to coordinate positions between the recreational objects. A controller triggers a collision alert to the first and/or second recreational object to indicate proximate collision.

Typically, the recreational paths, waterways, and airways are becoming more and more congested with recreational traffic. As traffic congestion and the velocity of moving recreational objects and people has increased, the number of accidents has also increased. Some of these accidents can be traced to inattentiveness or to the failure of the recreational objects and people to see other approaching barriers, vehicles, animals, and people. This is especially a problem in areas where there is little signage, large amounts of foliage, and the roads are uneven and windy.

It is known that there are systems for making drivers aware of objects external to them. Mirrors, and sometimes combinations of mirrors, have been used to reveal locations hidden to the driver's view (i.e. “blind spots”). Mirrors, however, have a deficiency in that the driver or recreational object can only look in one spot at any one time. If they look behind, they see that the way is clear, start looking elsewhere and then a vehicle, horse, or boat pulls behind them. Often they won't see it and may back into the vehicle.

Various technology-based methods have been proposed to reduce the number of collisions between barriers, vehicles, animals, and people. The basis of some of these methods is wireless transmission by a sending vehicle of its position and speed, then the computation by a receiving vehicle of a possible collision between the transmitting vehicle and the receiving vehicle by computing the future positions of both vehicle based on the received information combined with the position and speed information of the receiving vehicle. Then, either the driver of the receiving vehicle is warned to take evasive action or evasive action is initiated by the receiving vehicle automatically. However, in rural areas where wireless transmission of signals is not strong, and battery capacity is limited, this system has limited success.

It is also known that generally, automobile anti-collision systems are largely structured from several distance measuring devices and several image sensing systems, which enable measuring safe distances between vehicles when moving, and as soon as an abnormal condition is detected, then the anti-collision system self-activates the brake system or warning equipment, thereby substantially reducing accident occurrence.

Rural areas, such as forests, mountains, and parks also present problems with recreational users getting lost. A number of devices are known which provide mobile telecommunication capabilities for locating lost people and objects. Further, known position detection systems employ the known Global Positioning System (GPS), Global Orbiting Navigational System (GLONASS), Loran, RF triangulation, inertial frame reference and Cellular Telephone base site, e.g., time difference of arrival (TDOA) or nearest antenna proximity systems. It is also known that GPS mobile systems include memory to record location, time and event type, and some systems may be integrated with global information systems, to track path, speed, etc. However, these systems do not typically intercommunicate event information between units. Thus, the communications streams relate to position information only.

Other ground-based location determination devices use systems that were developed primarily for communications, such as cellular telephone, FM broadcast, and AM broadcast. Some cellular telephone systems provide estimates of location, using comparison of signal strengths from three or more sources. FM broadcast systems having subcarrier signals can provide estimates of location by measuring the phases of the subcarrier signals. However, these systems rely on radio towers, which are not always available in recreational and rural areas.

Typically, anti-collision systems operate independently of locating systems for finding lost people and objects. These two functions are separate and overlap is not found. The anti-collision requires bouncing signals between at least two objects, while the locating system must relay signals to an external site, such as a satellite or a radio tower.

Other proposals have involved anti-collision systems and locating systems for finding lost people and objects. The problem with these systems is that they do not provide sufficient functionality in rural and recreational areas. Also, they are separate and cannot perform both functions. Even though the above cited anti-collision and locating systems meet some of the needs of the market, a system and method that utilizes wireless communication between a first recreational object and a second recreational object moving towards each other in natural or semi-natural settings to alert against a collision threat, and also emits an emergency signal from any first recreational object to indicate location and other emergency communications. is still desired.

### SUMMARY

Illustrative embodiments of the disclosure are generally directed to a system and method for alerting to collision threats between moving recreational objects. The system and method also identifies the location of the first recreational object in emergency situations.

In some embodiments, the system and method may help a first recreational object and a second recreational object, which are moving towards each other, avoid collision threats in natural or semi-natural settings where few signs or clear pathways are available to prevent collisions. Once alerted, either the first recreational object is warned to take evasive action, or in some embodiments, evasive action is initiated by the first recreational object automatically. Though, in some embodiments, the first and second recreational objects are interchangeable, depending on the communication components possessed thereby.

In some embodiments, the system may emit an emergency signal between the transponder and a GPS enabled receiver, and/or a radio, and/or a software application to indicate the location of the first recreational object, and also to indicate other emergency related communications from the first recreational object to the second recreational object. However in other embodiments, any positioning system may be used to help locate the first recreational object. The strength of the signal is analyzed by a processor to interpret the position of the first recreational object. The same transponder that alerts to potential collision threats may also be used for indicating the location of the first recreational object.

Thus, the present system and method provides the dual purpose of alerting to collisions between a first recreational object and a second recreational object; also and indicating a location of a first recreational object in emergency situations. Both functions utilize substantially the same wireless communication components.

One aspect of the collision avoidance system for recreational objects comprises:
a transmitter configured to transmit a transponder interrogation signal;
a transponder configured to receive the transponder interrogation signal and transmit a reply signal thereto;
a receiver configured to receive the reply signal;
a processor configured to interpret the reply signal to designate the transmitter as a collision threat;
a controller configured to trigger a collision alert in response to the designation of the threat by the processor; and
a GPS-enabled receiver, and/or a radio, and/or a software application for synchronizing and communicating a position with the transponder.

In another aspect, the system is configured to alert the first recreational object against a collision threat with the second recreational object.

In another aspect, the system is configured to indicate the position and other emergency communications of the first recreational object.

In another aspect, the recreational objects include hikers, cyclers, motorcycle riders, jet skiers, hang gliders, and horseback riders.

In another aspect, the transponder integrates with the first recreational object 102.

In another aspect, the transmitter and the receiver integrates with the second recreational object.

In another aspect, the transponder interrogation signal and the reply signal comprise radio signals.

In another aspect, the emergency signal comprises a satellite signal.

In another aspect, the collision alert at the controller comprises, without limitation, a vibration, and/or an illumination, and/or an audio signal, and/or a Bluetooth enabled communication.

In some embodiments, the system and method may utilize wireless communication between the first recreational object and the second recreational object to generate a collision alert that indicates to the first recreational object that the second recreational object is proximal or moving at a high velocity. In essence, the collision alert indicates to the first recreational object that the second recreational object presents a collision threat.

In one embodiment, the system and method enables the first recreational object to continually scan a predetermined area—often forward—to perform the functions of: detecting the presence of the second recreational object; detecting the course and the relative speed of movement of the second recreational object; and predicting whether or not the second recreational object is moving on a threatened collision course with respect to the first recreational object. In one embodiment, a software application can be downloaded on a smartphone by a recreational object, such as hikers, to alert to collision threats from other recreational objects.

A transponder, which integrates into the first recreational object, exchanges radio signals with a transmitter and a receiver integrated into the second recreational object. In one suitable embodiment, a downloadable software application on a smartphone may perform the functions of the transponder, transmitter, and receiver. A processor interprets the strength and position of the signals to determine a potential collision threat between the first and second recreational objects. A controller generates a collision alert at the first recreational object when the collision threat is imminent.

In one possible embodiment, the first recreational object may emit an emergency signal between the transponder and a GPS enabled receiver, and/or a radio, and/or a software application to indicate location and other emergency related communications to the second recreational object and/or an external locator. In some embodiments, a plurality of recreational objects can receive and respond to the emergency signal from the first recreational object. In another embodiment, the second recreational object or an external locator can utilize various positioning systems to track and locate the first recreational object based on the emergency signal.

One objective of the present invention is to alert a first recreational object to a collision threat from a second recreational object positioned behind a barrier, through a conspicuous collision alert.

Another objective is to provide a system that will continually scan the area forward of the first recreational object and detect the presence of the second recreational object in the area; detect the course and the relative speed of movement of the second recreational object; and predict whether or not the second recreational object is moving on a threatened collision course with respect to the first recreational object.

Another possible objective is to provide a software application that can be downloaded on a smartphone by recreational objects, such as hikers, to alert to collision threats.

Another possible objective is to provide a system that interprets signal strength between the transponder and the GPS-enabled receiver, and/or radio, and/or a software application to locate the transponder based on, or relative to, the GPS coordinates of the GPS-enabled receiver or signal strength of the radio.

Another objective is to provide an emergency signal that alerts to emergencies, such as accidents, getting lost, attacks, and abductions.

Yet another objective is to produce a system that is mandatory to be used in federal parks and other recreational areas to alert for collision threats.

Yet another objective is to generate revenue by selling subscriptions to receive permission to utilize the system.

Yet another objective is to provide an inexpensive collision alert system that can be easily used by a plurality of recreational hikers, cyclers, and horseback riders.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a block diagram of an exemplary system for alerting a first recreational object to a collision threat from a second recreational object, in accordance with an embodiment of the present invention;

FIG. 2 illustrates a block diagram of an exemplary system for locating a first recreational object emitting an emergency signal to an external locator, and a second recreational object identifying the location of the first recreational object, in accordance with an embodiment of the present invention;

FIG. 3 illustrates a flowchart diagram of an exemplary method for alerting a first recreational object to a collisions threat from a second recreational object and identifying the location of the first recreational object, in accordance with an embodiment of the present invention; and

FIG. 4 illustrates a block diagram depicting an exemplary client/server system which may be used by an exemplary web-enabled/networked, in accordance with an embodiment of the present invention.

Like reference numerals refer to like parts throughout the various views of the drawings.

### DETAILED DESCRIPTION OF THE INVENTION

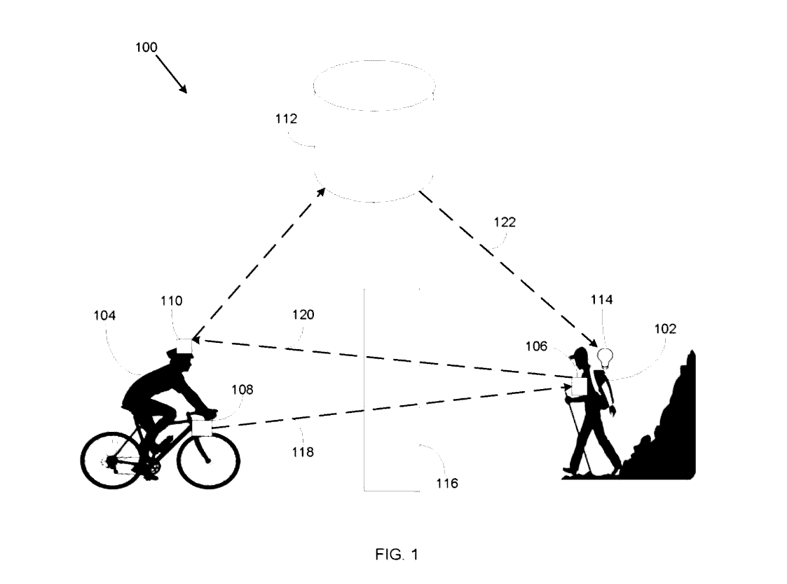

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

In one embodiment of the present invention presented in FIGS. 1-4, a collision avoidance system 100 and method 200 helps a first recreational object 102 and a second recreational object 104, moving towards each other, avoid collision threats in natural or semi-natural settings where few signs or clear pathways are available to prevent collisions. Once alerted, either the first recreational object 102 is warned to take evasive action, or in some embodiments, evasive action is initiated by the first recreational object 102 automatically. The system 100 and method 200 also identifies the location of the first recreational object 102 or the second recreational object 104 in emergency situations. The first or second recreational objects 102, 104 or an external locator 124, such as a GPS enabled receiver, and/or a radio, and/or a software application can utilize various positioning systems to track and locate the respective lost recreational object 102, 104.

In some embodiments, the system 100 and method 200 may utilize wireless communication between the first recreational object 102 and the second recreational object 104 to generate a collision alert that indicates to the first recreational object 102 that the second recreational object 104 is proximal or moving at a high velocity towards each other. In essence, the collision alert indicates to the first recreational object 102 that the second recreational object 104 presents a collision threat. Though, in some embodiments, the first and second recreational objects 102, 104 are interchangeable, depending on the type of communication components possessed thereby.

In some embodiments, the system 100 may emit an emergency signal 122 between the transponder 106 and a GPS enabled receiver, and/or a radio, and/or a software application to indicate the location of the first recreational object 102, and also to indicate other emergency related communications from the first recreational object 102 to the second recreational object 104. However in other embodiments, any positioning system may be used to help locate the first recreational object. The strength of the signal is analyzed by a processor 112 to interpret the position of the first recreational object 102. The same transponder 106 that alerts to potential collision threats may also be used for indicating the location of the first recreational object.

Thus, the present system and method provides the dual purpose of alerting to collisions between a first recreational object 102 and a second recreational object 104; also and indicating a location of a first recreational object 102 in emergency situations. Both functions utilize substantially the same wireless communication components.

In one embodiment, the system 100 and method 200 enables the first recreational object 102 to continually scan a predetermined area—often forward—to perform the functions of: detecting the presence of the second recreational object 104; detecting the course and the relative speed of movement of the second recreational object 104; and predicting whether or not the second recreational object 104 is moving on a threatened collision course with respect to the first recreational object 102. In one embodiment, a software application can be downloaded on a smartphone by a recreational object 102, such as hikers, to alert to collision threats from other recreational objects 102, 104.

A transponder 106, which integrates into the first recreational object 102, exchanges radio signals with a transmitter 108 and a receiver 110 integrated into the second recreational object 104. In one suitable embodiment, a downloadable software application on a smartphone may perform the functions of the transponder 106, transmitter 108, and receiver 110. A processor 112 interprets the strength and position of the signals to determine a potential collision threat between the first and second recreational objects 102, 104. A controller 114 generates a collision alert at the first recreational object 102 when the collision threat is imminent.

In some embodiments, the system 100 may emit an emergency signal 122 between the transponder 106 and a GPS enabled receiver, and/or a radio, and/or a software application to indicate the location of the first recreational object 102, and also to indicate other emergency related communications from the first recreational object 102 to the second recreational object 104. However in other embodiments, any positioning system may be used to help locate the first recreational object 102.

In some embodiments, the recreational objects 102, 104 may include, without limitation, hikers, horse riders, cyclers, motor cycle riders, kayakers, and sports participants. Those skilled in the art, in light of the present teachings, will recognize that recreational activities are often engaged in the outdoors, in natural or semi-natural settings, such as mountains, forests, fields, deserts, and large bodies of water. Examples of recreational activities may include, without limitation, hiking, cycling, adventure horseback riding, mountain bike riding, racing, backpacking, canoeing, caving, hunting, kayaking, mountaineering, adventure park exploring, rock climbing, running, sailing, skiing, and surfing.

Generally, these recreational activities occur in trails, mountains, and fields, where signage, smooth pathways, and communication means are not always available. Often, blind corners, trees, brush, dark areas, and hilltops do not offer sufficient visibility for the first recreational object 102 to detect an oncoming second recreational object 104, or vice versa. Further, the means of conveyance for recreational activities, such as a horse or mountain bike, generally do not have the most efficient braking mechanisms to stop instantaneously, and thus avoid a collision. Thus, the most effective way to avoid collisions in the recreational environment is to provide an early warning, such as the aforementioned collision alert, through the use of wireless communication. This serves to enhance the conspicuousness of the second recreational object 104 that presents a collision threat to the first recreational object 102.

FIG. 1 references the collision avoidance system 100. The system 100 helps a first recreational object 102 and a second recreational object 104 that are moving towards each other to avoid collisions in natural or semi-natural settings where few signs or clear pathways are available to prevent collisions, and where a barrier 116 may restrict visual confirmation between the first and second recreational objects 102, 104. The system 100 is also effective for transmitting an emergency signal 122 to indicate the location of the first recreational object 102 to the second recreational object 104.

The first recreational object 102 includes a transponder 106 that is integrated therein. The transponder 106 is configured to emit an identifying signal in response to an interrogating received signal for identification, indication of the location of the first recreational object 102, and communication with the second recreational object 104. The signal emitted by the transponder 106 can be a radio signal. Though in other embodiments the signal may transmit through Wi-Fi and satellite communications.

In some embodiments, the transponder 106 may be embedded in an article of the first recreational object 102, such as a shoe, a backpack, or a saddle. However in other embodiments, the transponder 106 can take the shape of, or be incorporated on or in, many convenient forms, including but not limited to straps, clips, pins, wrist bands, necklaces, chains and clothing units, so as to be comfortably and discretely worn by the first recreational object 102.

The second recreational object 104 includes a transmitter 108 that emits a transponder interrogation signal 118, often in the form of a radio signal. The transponder 106 receives the transponder interrogation signal 118, which triggers the transponder 106 to emit a reply signal 120 to the transponder interrogation signal 118. Thus, the transponder 106 transmits the reply signal 120 upon receiving the transponder interrogation signal 118 from the transmitter 108. In essence, the first recreational object 102 and the second recreational object 104 are in communication, despite the barrier 116, which restricting visual confirmation between the first and second recreational objects 102, 104.

In addition to the transmitter 108, a receiver 110 is operatively connected to the second recreational object 104. The receiver 110 is configured to receive the reply signal 120 from the transponder 106. In one possible embodiment, proprietary software is installed in the receiver 110 that can then be used to synchronize the receiver 110 with the transponder 106 by keying in an appropriate transponder code. Then, when the location of the transponder 106, and hence when the position of the first recreational object 102, is determined, the appropriate transponder code can be input into the receiver 110, thereby sending out another transponder interrogation signal 118 to be received by the transponder 106. This causes the transponder 106 to send another reply signal 120 back to the receiver 110. Thus, a perpetual communication between the first recreational object 102 and the second recreational object 104 is perpetuated for alerting to collision threats.

As illustrated in FIG. 1, a processor 112 interprets the strength and position of the signals 118, 120 between the first recreational object 102 and the second recreational object 104 to determine a potential collision threat. The processor 112 comprises an algorithm that is configured to calculate distance, velocity, positions, and obstructions from the barrier 116 in determining whether a collision threat is imminent. The processor 112 may be integrated into the transponder 106, the transmitter 108, or the receiver 110. However, in other embodiments, the processor 112 may be remotely located and in constant communication with the transponder 106. The processor 112 is operatively connected to a controller 114, which integrates with the first recreational object 102.

The controller 114 is configured to trigger a collision alert in response to the designation of the collision threat by the processor 112. The controller 114 generates the collision alert conspicuously to the first recreational object 102 when the collision threat is imminent, i.e., the first and second recreational objects 102, 104 are at a predetermined distance, and moving at a predetermined velocity. The collision alert is sufficiently conspicuous to catch the attention of the first recreational object 102.

In one possible embodiment, a visual indication is provided by the collision alert in the form of a plurality of lights which are progressively illuminated to indicate a reduction in the distance between the first recreational object and the second recreational object. In some embodiments, the collision alert may include a vibration, an illumination, and an audio signal. Other possible collision alerts may include, without limitation, a human voice, an electrical shock, an increase in temperature, and a guidance system that takes control of the steering from the first recreational object 102.

For example, without limitation, a hiker walking around a barrier 116, such as a blind corner on a mountain trail, does not see an approaching cycler. However, the transponder 106 communicates with the receiver 110 to indicate a potential collision threat with the cycler. The controller 114 subsequently triggers to indicate the collision threat. The hiker feels a vibration, sees a flashing light, and hears a beeping sound from the controller 114 to indicate that the cycler is coming around the blind corner. Thus, the hiker is made aware to stand off to the side of the pathway until the cycler passes.

In yet another example, the collision avoidance system 100 may be effectively integrated in mountain bike riding. Those skilled in the art will recognize that in the art of mountain bike riding, handle bar bells are utilized to try to prevent accidents by ringing a mechanical bell on the handle bars to inform other riders or people on the path that the mountain bike is oncoming or passing. Further, many State park systems mandate that mountain bikes have these handle bar bells.

As discussed above, the present invention utilizes a controller 114 that is configured to trigger a collision alert. In one embodiment, the controller 114 is an electronic embodiment of the bell on the handle bar of the mountain bike. For example, a mountain bike rider can press a button that will actuate the sound of a bell sound to any oncoming traffic by triggering the transponder 106. The sound is in the form of an electronic bell, imitating the sound of the mechanical bell. The transponder 106 and receiver 110 operate in the same manner as described above, even when this electronic bell is used. The electrical bell actuated by the controller described in this embodiment can be used as part, or independently of the collision avoidance system 100.

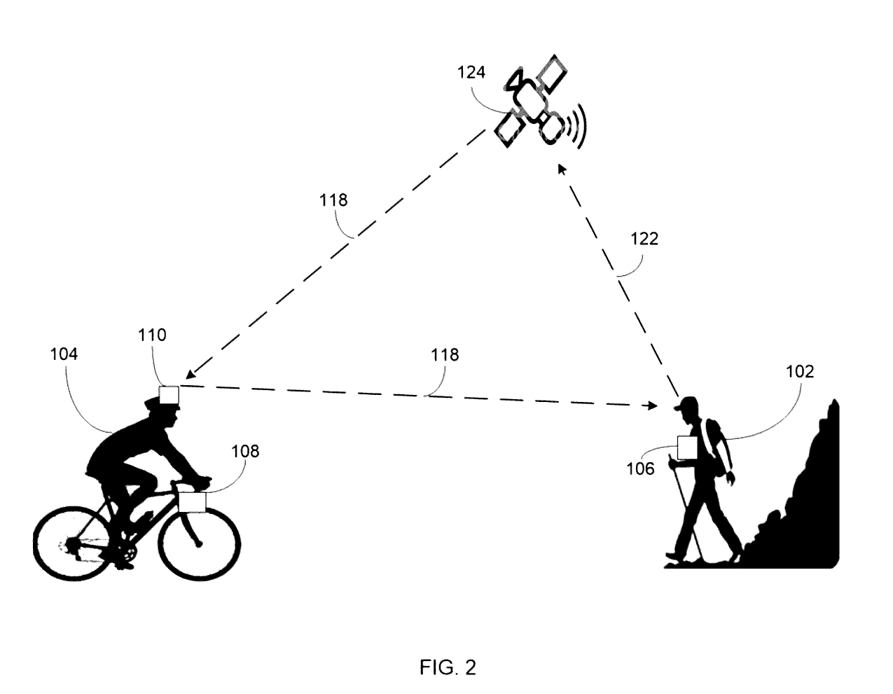

Turning now to FIG. 2, the system 100 may also enable the transponder 106 to emit an emergency signal 122 from the first recreational object 102 to an external locator, such as a GPS-enabled receiver, and/or a radio, and/or a software application for indicating the location and other emergency related communications to the second recreational object 104. In this manner, the first recreational object 102 can indicate an emergency situation, such as being lost, being injured, being trapped, being kidnapped, and other emergency predicaments.

In one possible embodiment, the first recreational object 102 may emit an emergency signal 122 between the transponder 106 and a GPS enabled receiver, and/or a radio, and/or a software application to indicate location and other emergency related communications to the second recreational object 104 or an external locator 124. In another embodiment, the second recreational object 104 or the external locator 124 can utilize various positioning systems to track and locate the first recreational object 102 based on the emergency signal 122.

For example, horseback riders, picnickers, boaters, and cyclers in the proximity of the first recreational object 102 can call emergency response professionals to the exact position of the first recreational object 102 as soon as the emergency signal 122 is emitted. In one alternative embodiment, the system 100 is mandatory to be used in federal parks and other recreational areas to alert for collision threats. In another embodiment, the transponder 106, the transmitter 108, and the receiver 110 are embedded in a smartphone.

In one embodiment, the position of the first recreational object 102 is determined by interpreting the signal strength from the transponder. The processor 112 may then calculate the geographic position of the transponder 106, and thereby the first recreational object 102. In one embodiment, calculating the signal strength, and thereby locating a position of the first recreational object 102 includes fixing a first reference point based on the location of the GPS-enabled receiver, and/or radio, and/or software application; fixing a second reference point based on the location of a network broadcast site (not shown) through which the GPS-enabled receiver and the transponder 106 communicate; and calculating the location of the transponder 106 based on the angular position of the transponder 106 relative to the network broadcast site. In this manner, the distance and direction of the transponder 106 from the GPS-enabled receiver is determined in order to guide the second recreational object 104 in the direction of the transponder 106, and thus the first recreational object 102.

The external locator, in the form of a GPS-enabled receiver, and/or the radio, and/or the software application initially must synchronize with the transponder 106 to calculate and communicate a position of the transponder 106. After installing the necessary software onto the GPS-enabled receiver, the GPS-enabled receive is synchronized with the transponder 106 and configured for monitoring and tracking the location of the transponder 106. In one embodiment, the GPS-enabled receiver is a satellite. However, in other embodiments, the GPS-enabled receiver may include a cellular phone in operational communication with the satellite that is maintained by the second recreational object 104. In other alternate embodiments, the GPS-enabled receiver may be a PDA, personal computer, or any other electronic device, now known or later developed, having GPS capabilities.

In one embodiment, the system 100 generates revenue by selling subscriptions to permissions for sending and receiving the signals 118, 120, 122. Additional revenue may be generated by selling or renting the transponder, 106, the transmitter 108, and the receiver 110. Yes more revenue may be generated through advertising, whereby the controller 114 emits an audio signal of an advertisement jingle or human voice. However, in another alternative embodiment, the system 100 may be given as a free public service at parks and recreational zones, as part of the price of admission.

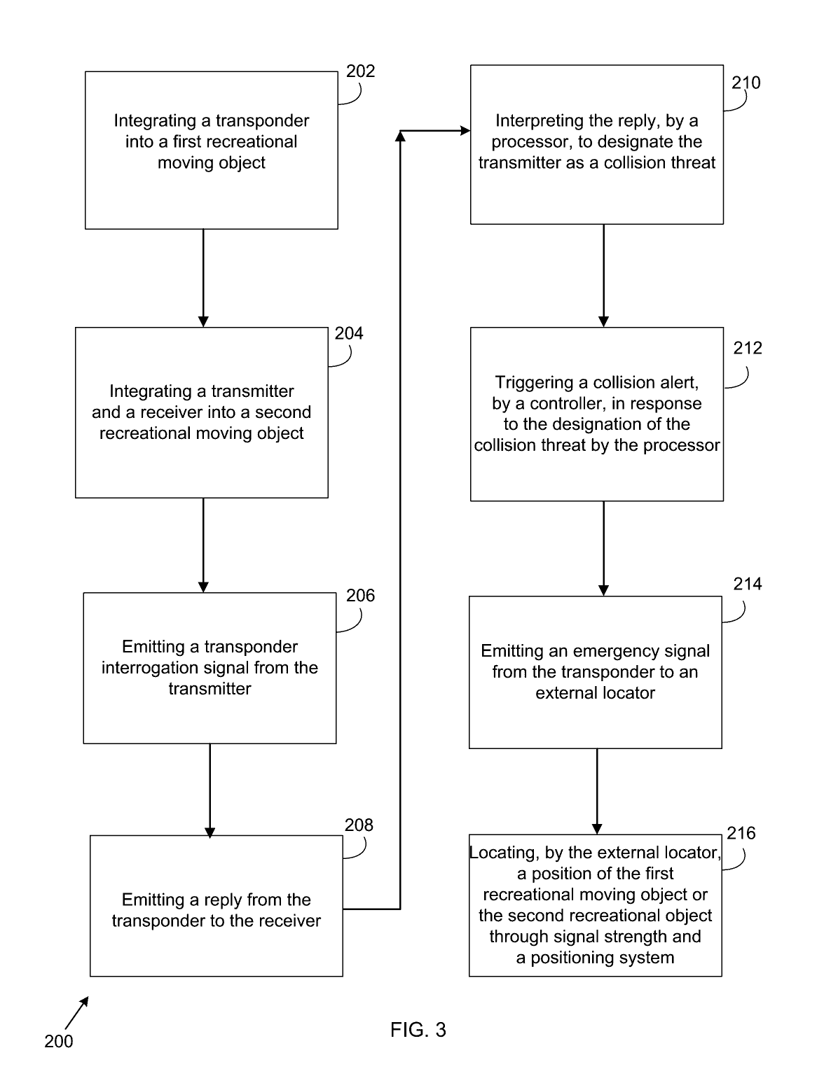

FIG. 3 illustrates a flowchart diagram of an exemplary method 200 for avoiding collisions between a first and second recreational object 104. The method 200 helps a first recreational object 102 and a second recreational object 104 avoid collisions in natural or semi-natural settings where few signs or clear pathways are available to prevent collisions. The method 200 utilizes wireless communication between a first recreational object 102 and a second recreational object 104 to generate a collision alert to indicate that the second recreational object 104 presents a collision threat. The method also emits an emergency signal 122 from the transponder 106 of the first recreational object 102 to a GPS-enabled receiver, and/or radio, and/or software application for indicating the location and other emergency related communications to the second recreational object 104.

The method 200 may include an initial Step 202 of integrating a transponder 106, and/or a transmitter 108, and/or a receiver 110 into a first recreational object 102. The first recreational object 102 includes a transponder 106 that is integrated therein. The transponder 106 is configured to emit an identifying signal in response to an interrogating received signal for identification, indication of the location of the first recreational object 102, and communication with the second recreational object 104.

The method 200 may further comprise a Step 204 of integrating the transponder 106, and/or the transmitter 108, and/or the receiver 110 into a second recreational object 104. The second recreational object 104 includes a transmitter 108 that emits a transponder interrogation signal 118, often in the form of a radio signal. The transponder 106 receives the transponder interrogation signal 118, which triggers the transponder 106 to emit a reply signal 120 to the transponder interrogation signal 118. Thus, the transponder 106 transmits the reply signal 120 upon receiving the transponder interrogation signal 118 from the transmitter 108. In addition to the transmitter 108, a receiver 110 is operatively connected to the second recreational object 104. The receiver 110 is configured to receive the reply 120 from the transponder 106.

A Step 206 includes emitting a transponder interrogation signal 118 from the transmitter 108. The transponder 106 receives the transponder interrogation signal 118 from the transmitter 108. In some embodiments, a Step 208 comprises emitting a reply signal 120 from the transponder 106 to the receiver 110. The transponder interrogation signal 118 triggers the transponder 106 to emit a reply signal 120 to the receiver 110. Thus, the transponder 106 transmits the reply signal 120 upon receiving the transponder interrogation signal 118 from the transmitter 108.

A Step 210 includes interpreting the reply signal 120, by a processor 112, to designate the transmitter 108 as a collision threat. The processor 112 comprises an algorithm that is configured to calculate distance, velocity, positions, and obstructions from the barrier 116 in determining whether a collision threat is imminent. The processor 112 may be integrated into the transponder 106, the transmitter 108, or the receiver 110.

In some embodiments, a Step 212 may include triggering a collision alert, by a controller 114, in response to the designation of the collision threat by the processor 112. The collision alert is sufficiently conspicuous to catch the attention of the first recreational object 102. The collision alert may include a vibration, an illumination, and an audio signal. A Step 214 comprises emitting an emergency signal 122 from the transponder 106 to a GPS-enabled receiver, and/or a radio, and/or a software application.

A final Step 216 includes locating a position of the first recreational object 102 or the second recreational object 104. The method 200 emits an emergency signal 122 from the transponder 106 of the first recreational object 102 or the second recreational object 104 to an external locator 124, such as a GPS-enabled receiver, and/or radio, and/or software application for indicating the location and other emergency related communications to the second recreational object 104. However in other embodiments, any software application being configured to transmit and receive a radio signal may be used.

In this manner, the first recreational object 102 can indicate an emergency situation, such as being lost, being trapped, being kidnapped, and other dangerous predicaments. The signal strength between the transponder and the GPS-enabled receiver, and/or radio, and/or software application is interpreted by the processor 112. The location may then be determined by fixing a first reference point based on the location of the GPS-enabled receiver, and/or radio, and/or software application; fixing a second reference point based on the location of a network broadcast site through which the receiver 110 and transponder 106 communicate; and calculating the location of the transponder 106 based on the angular position of the transponder 106 relative to the network broadcast site.

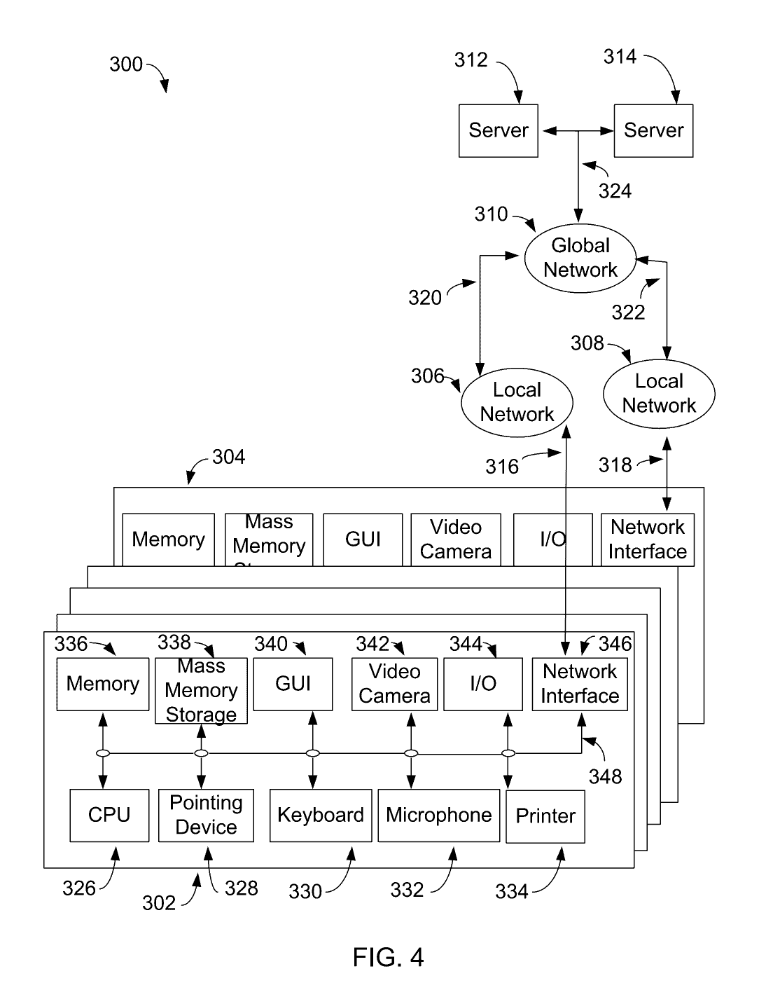

FIG. 4 is a block diagram depicting an exemplary client/server system which may be used by an exemplary web-enabled/networked embodiment of the present invention. In one embodiment, a communication system 300 includes a multiplicity of clients with a sampling of clients denoted as a client 302 and a client 304, a multiplicity of local networks with a sampling of networks denoted as a local network 306 and a local network 308, a global network 310 and a multiplicity of servers with a sampling of servers denoted as a server 312 and a server 314.

Client 302 may communicate bi-directionally with local network 306 via a communication channel 316. Client 304 may communicate bi-directionally with local network 308 via a communication channel 318. Local network 306 may communicate bi-directionally with global network 310 via a communication channel 320. Local network 308 may communicate bi-directionally with global network 310 via a communication channel 322. Global network 310 may communicate bi-directionally with server 312 and server 314 via a communication channel 324. Server 312 and server 314 may communicate bi-directionally with each other via communication channel 324. Furthermore, clients 302, 304, local networks 306, 308, global network 310 and servers 312, 314 may each communicate bi-directionally with each other.

In one embodiment, global network 310 may operate as the Internet. It will be understood by those skilled in the art that communication system 300 may take many different forms. Non-limiting examples of forms for communication system 300 include local area networks (LANs), wide area networks (WANs), wired telephone networks, wireless networks, or any other network supporting data communication between respective entities.

Clients 302 and 304 may take many different forms. Non-limiting examples of clients 302 and 304 include personal computers, personal digital assistants (PDAs), cellular phones and smartphones.

Client 302 includes a CPU 326, a pointing device 328, a keyboard 330, a microphone 332, a printer 334, a memory 336, a mass memory storage 338, a GUI 340, a video camera 342, an input/output interface 344 and a network interface 346.

CPU 326, pointing device 328, keyboard 330, microphone 332, printer 334, memory 336, mass memory storage 338, GUI 340, video camera 342, input/output interface 344 and network interface 346 may communicate in a unidirectional manner or a bi-directional manner with each other via a communication channel 348. Communication channel 348 may be configured as a single communication channel or a multiplicity of communication channels.

CPU 326 may be comprised of a single processor or multiple processors. CPU 326 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 336 is used typically to transfer data and instructions to CPU 326 in a bi-directional manner. Memory 336, as discussed previously, may include any suitable computer-readable media, intended for data storage, such as those described above excluding any wired or wireless transmissions unless specifically noted. Mass memory storage 338 may also be coupled bi-directionally to CPU 326 and provides additional data storage capacity and may include any of the computer-readable media described above. Mass memory storage 338 may be used to store programs, data and the like and is typically a secondary storage medium such as a hard disk. It will be appreciated that the information retained within mass memory storage 338, may, in appropriate cases, be incorporated in standard fashion as part of memory 336 as virtual memory.

CPU 326 may be coupled to GUI 340. GUI 340 enables a user to view the operation of computer operating system and software. CPU 326 may be coupled to pointing device 328. Non-limiting examples of pointing device 328 include computer mouse, trackball and touchpad. Pointing device 328 enables a user with the capability to maneuver a computer cursor about the viewing area of GUI 340 and select areas or features in the viewing area of GUI 340. CPU 326 may be coupled to keyboard 330. Keyboard 330 enables a user with the capability to input alphanumeric textual information to CPU 326. CPU 326 may be coupled to microphone 332. Microphone 332 enables audio produced by a user to be recorded, processed and communicated by CPU 326. CPU 326 may be connected to printer 334. Printer 334 enables a user with the capability to print information to a sheet of paper. CPU 326 may be connected to video camera 342. Video camera 342 enables video produced or captured by user to be recorded, processed and communicated by CPU 326.

CPU 326 may also be coupled to input/output interface 344 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 326 optionally may be coupled to network interface 346 which enables communication with an external device such as a database or a computer or telecommunications or internet network using an external connection shown generally as communication channel 316, which may be implemented as a hardwired or wireless communications link using suitable conventional technologies. With such a connection, CPU 326 might receive information from the network, or might output information to a network in the course of performing the method steps described in the teachings of the present invention.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

1. A system for alerting a first recreational object to a collision threat from a second recreational object and locating the first recreational object or the second recreational object, the system comprises:
a transmitter configured to transmit a transponder interrogation signal;
a transponder configured to receive the transponder interrogation and transmit a reply signal thereto, the transponder further configured to transmit an emergency signal;
a receiver configured to receive the reply signal;
an external locator configured to receive the emergency signal for synchronizing and communicating a position with the transponder;
a processor configured to interpret the reply signal to designate the transmitter as a collision threat; and
a controller configured to trigger a collision alert in response to the designation of the threat by the processor.

2. The system of claim 1, further including a GPS-enabled receiver for synchronizing and communicating the position with the transponder.

3. The system of claim 1, further including a radio for synchronizing and communicating the position with the transponder.

4. The system of claim 1, further including a software application for synchronizing and communicating the position with the transponder.

5. The system of claim 1, wherein the transponder interrogation signal, the reply signal, and the emergency signal comprise a radio signal.

6. The system of claim 1, wherein the collision alert includes at least one member selected from the group consisting of: a vibration, an illumination, and an audio signal.

7. The system of claim 1, wherein a visual indication is provided by the collision alert in the form of a plurality of lights which are progressively illuminated to indicate a reduction in the distance between the object and the vehicle.

8. The system of claim 1, wherein the first recreational object includes at least one member selected from the group consisting of: hikers, cyclers, motorcycle riders, jet skiers, hang gliders, and horseback riders.

9. The system of claim 1, wherein the second recreational object includes at least one member selected from the group consisting of: hikers, cyclers, motorcycle riders, jet skiers, hang gliders, and horseback riders.

10. A system for alerting a first recreational object to a collision threat from a second recreational object and locating the first recreational object, the system comprises:
a transmitter configured to transmit a transponder interrogation signal;
a transponder configured to receive the transponder interrogation and transmit a reply signal thereto;
a receiver configured to receive the reply signal;
a GPS enabled receiver, or a radio, or a software application configured to receive the emergency signal for synchronizing and communicating a position with the transponder;
a processor configured to interpret the reply signal to designate the transmitter as a collision threat; and
a controller configured to trigger a collision alert in response to the designation of the threat by the processor.

11. The system of claim 10, wherein the transponder interrogation signal and the reply signal comprise a radio signal.

12. The system of claim 10, wherein the collision alert includes at least one member selected from the group consisting of: a vibration, an illumination, and an audio signal.

13. The system of claim 10, wherein a visual indication is provided by the collision alert in the form of a plurality of lights which are progressively illuminated to indicate a reduction in the distance between the first recreational object and the second recreational object.

14. A method for alerting a first recreational object to a collision threat from a second recreational object and locating the first recreational object, the method comprising:
integrating a transponder, and/or a transmitter, and/or a receiver into a first recreational object;
integrating the transponder, and/or the transmitter, and/or the receiver into a second recreational object;
emitting a transponder interrogation signal from the transmitter;
emitting a reply signal from the transponder to the receiver;
interpreting the reply signal, by a processor, to designate the transmitter as a collision threat;
triggering a collision alert, by a controller, in response to the designation of the collision threat by the processor;
emitting an emergency signal from the transponder to an external locator; and
locating, by the external locator, a position of the first recreational object or the second recreational object by:
fixing a first reference point based on the location of the external locator,
fixing a second reference point based on the location of a network broadcast site through which the receiver and transponder communicate, and
and calculating the location of the transponder based on the angular position of the transponder relative to the network broadcast site.

15. The method of claim 14, further including the step of emitting an emergency signal from the transponder to a GPS-enabled receiver.

16. The method of claim 15, further including the step of emitting an emergency signal from the transponder to a radio.

17. The method of claim 16, further including the step of fixing a first reference point based on the location of the GPS-enabled receiver.

18. The method of claim 17, further including the step of fixing a first reference point based on the location of the radio.

19. The system of claim 18, wherein the transponder interrogation signal and the reply signal comprise a radio signal.

20. The system of claim 19, wherein the step of locating a position of the first recreational object is performed by the external locator or the second recreational
